(19) United States
(12) Patent Application Publication
(10) Pub. No.: US 2017/0291185 A1
(43) Pub. Date: Oct. 12, 2017

(54) Dispenser Container

(71) Applicant: YONWOO CO., LTD., Incheon (KR)

(72) Inventors: Sung-Hwan Kim, Incheon (KR); Sung-Sin Kim, Incheon (KR)

(73) Assignee: YONWOO CO., LTD., Incheon (KR)

(21) Appl. No.: 15/506,832

(22) PCT Filed: Aug. 17, 2015
(86) PCT No.: PCT/KR2015/008546

§ 371 Date: Feb. 27, 2017

(30) Foreign Application Priority Data
Aug. 28, 2014 (KR) 10-2014-0112847

(51) Int. Cl. B05B 11/00; A45D 40/00; A45D 34/02

(52) U.S. Cl. CPC B05B 11/3047; A45D 34/02; A45D 40/0075; B05B 11/0054; A45D 2200/056; A45D 2034/005

(57) ABSTRACT

Provided is an airless compact container. The airless compact container blocks air from flowing into a refill container through a pumping member and thus prevents contents from being corrupted by inserting the refill container provided with the pumping member into one side of a middle case and then allowing contents to be discharged to the upper surface of a content outlet part through the pumping operation of the pumping member when a user pressurizes the lower end portion of the refill container.

### TECHNOLOGICAL FIELD

The present disclosure relates to a dispenser container, more particularly, a dispenser container which is possible to cut down cost due to reduction of the number of elements by having a structure of a pumping member changed and also to shorten an overall manufacturing time through simplified assemble procedure.

### BACKGROUND

Generally, a dispenser container has a structure wherein contents are discharged by a pumping operation of a pumping member. This type of a dispenser container is disclosed in Korean registered patent no. 10-0456814 (hereafter, it is called as the registered patent).

The registered patent has a dispenser pump which includes a screw cap (2) combined to an opening of a container (1); a button (3) formed on the top of the screw cap (2) to move up and down and having a nozzle (4); a stem (6) combined on the lower portion of the button (3) to be connected with the nozzle (4) therethrough; a cylinder housing (10) whose top is combined with the screw cap (2) and whose bottom opening (15) comprises a check valve (14); a piston (9) combined to the bottom of the stem (6) to move up and down in the cylinder housing (10); and a sealing part (12) combined around the piston (9). The dispenser pump is characterized to further comprise an upper ring part (22) inserted into the upper portion of the step (6) and its position is regulated by an upper stopper (21); and a lower ring part (24) inserted into the lower portion of the step (6) and arranged on the upper portion of the piston (9), wherein a spring (8) is installed between the upper ring part (22) and the lower ring part (24).

A dispenser container configured with the structure as the above has a pumping member with a number of elements such as a stem (6), a piston (9), a cylinder housing (10), a sealing member and so on. As a result, due to the number of elements in the dispenser container, there arise problems of a cost rise and an increase of overall manufacturing time caused by complexity of an assembling process.

### SUMMARY OF THE DISCLOSURE

The present disclosure is devised to solve such problems described in the above and to provide a dispenser container by changing the structure of a pumping member such that is possible to cut down manufacturing cost due to reduction of the number of elements by having a structure of a pumping member changed and also to shorten the overall manufacturing time through simplified assembling process.

To solve such problems in the above, embodiments of the presently described embodiments provide a dispenser container, the dispenser container comprising a container body where contents are stored, a pumping member which is coupled to an upper portion of the container body and discharges the contents stored in the container body to the outside by means of a pumping operation, and a button member which is disposed at an upper portion of the pumping member, delivering a pressure according to a user's manipulation to the pumping member and causing a pumping operation, and forming a discharging hole where contents are discharged,

wherein the pumping member is characterized to include: a pump housing coupled to an upper portion of the container body and providing a cylinder at a center thereof; a piston rod, an upper portion of which is coupled to an inner side of the button member and a lower portion of which is disposed at an inner side of the cylinder and moves along with an ascent/descent of the button member, including a content movement passage at a lower side thereof such that contents can move, and a content movement hole at a lower portion thereof such that contents can move to the content movement passage; a seal cap, made of soft material, which encases the piston rod and moves along an inner wall of the cylinder when the button member ascends/descends and changes inner pressure of the cylinder, further including an opening/closing tip so as to be separated with a small gap from an outer circumferential surface of the piston rod when the piston rod descends according to pressurization of the button member and opens a content movement hole; and an elastic body providing an elastic force such that the button member can move to an upper direction.

Furthermore, at the button member is provided a coupling part to which the piston rod is coupled, wherein the coupling part is characterized to pressurize the seal cap when the button member descends, and to guide the seal cap to a downward direction, and further to connect the content movement passage and the discharging hole such that contents can move to the discharging hole through the content movement passage.

Furthermore, it is characterized that at an upper end of the pump housing is formed a securing protrusion where a lower end of the elastic body secures, and at an inner side of the button member is formed a support groove which supports an upper end of the elastic body.

Meanwhile, other embodiments provide a dispenser container, the dispenser container comprising a container body where contents are stored, a pumping member which is coupled to an upper portion of the container body and discharges the contents stored in the container body to the outside through a pumping operation, and a button member which is disposed at an upper portion of the pumping member, delivering a pressure according to a user's manipulation to the pumping member and causing pumping operation, and forming a discharging hole where contents are discharged,

wherein the pumping member is characterized to include: a pump housing coupled to an upper portion of the container body and providing a cylinder at a center thereof; a piston rod, an upper portion of which is coupled to an inner side of the button member and a lower portion of which is disposed at an inner side of the cylinder and moves along with an ascent/descent of the button member; a seal cap, made of soft material, which encases the piston rod and moves along an inner wall of the cylinder when the button member ascends/descends and thereby changes inner pressure of the cylinder, further comprising an opening/closing tip so as to be separated with a small gap from an outer circumferential surface of the piston rod when the piston rod descends according to pressurization of the button member and opens a content movement hole; and an elastic body providing an elastic force such that the button member can move to an upper direction,

wherein it is characterized that when the button member is pressurized, a content movement passage is provided between the seal cap and piston rod such that contents having moved into the cylinder can move to a discharging hole.

Furthermore, it is characterized that at an inner side of the button member is provided a space where an upper portion of the seal cap ascends/descends and a connection tube which connects the content movement passage and the discharging hole.

Furthermore, it is characterized that the upper portion of the seal cap having a piston shape ascends/descends in a state of being contacted to an inner circumferential surface of the connection tube so as to prevent the contents moving to the discharging hole through the content movement passage from being leaked.

Furthermore, it is characterized that at the button member is provided a coupling part where the piston rod is coupled, wherein the coupling part pressurizes the seal cap when the button member descends and thus guides the seal cap to a downward direction. However, a front surface part of the coupling part disposed to a direction of the discharging hole is configured to be short and thereby prevents interference when the contents are discharged.

Furthermore, it is characterized that at the upper portion of the seal cap is provided a pressurization face pressurized by the coupling part.

Furthermore, it is characterized that at an inner circumferential surface of the pump housing is provided a protrusion which limits the ascent of the seal cap, and at an outer circumferential surface of the seal cap is provided a support protrusion which is supported by the protrusion.

As described in the above, it is possible to reduce cost due to the reduction of the number of parts by changing the structure of a pumping member, and also to shorten an overall manufacturing time by reducing the manufacturing procedure.

### BRIEF DESCRIPTION OF THE DRAWINGS

FIG. 1 is an exploded perspective view illustrating a configuration of a dispenser container according to an exemplary embodiment.

FIG. 2 is a cross-sectional view illustrating a configuration of a dispenser container according to an exemplary embodiment.

FIGS. 3 and 4 are views illustrating an operational state of a dispenser container according to an exemplary embodiment.

FIG. 5 is a cross-sectional view illustrating a dispenser container according to another exemplary embodiment.

FIGS. 6 and 7 is a view illustrating an operational state of a dispenser container according to another exemplary embodiment.

### DETAILED DESCRIPTION OF PREFERRED EMBODIMENTS

Hereinafter, exemplary embodiments will be described in detail with reference to the accompanying drawings. The same reference numerals provided in the drawings indicate the same members.

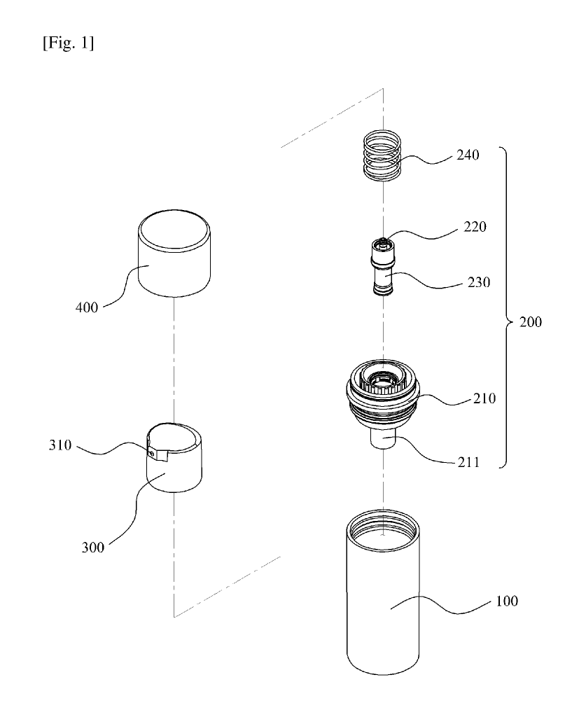

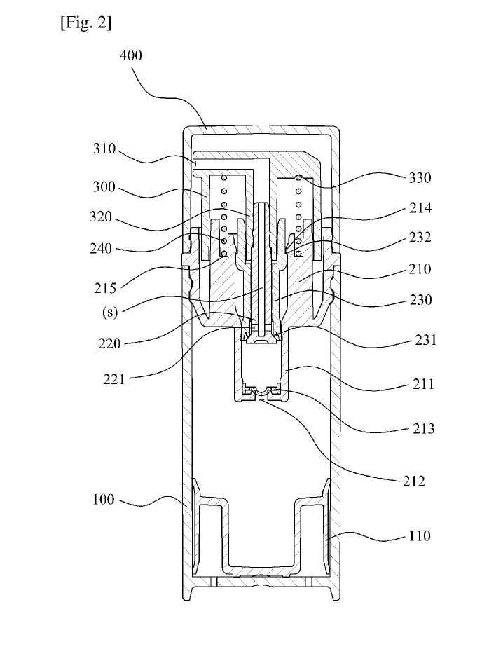

FIG. 1 is an exploded perspective view illustrating a configuration of a dispenser container according to an exemplary embodiment, and FIG. 2 is a cross-sectional view illustrating a configuration of a dispenser container according to an exemplary embodiment.

Referring to FIGS. 1 to 2, a dispenser container according to an exemplary embodiment may include a container body 100, a pumping member 200, and button member 500.

The container body 100, where contents is stored, includes a piston 110 which ascends according to contents use at a lower portion thereof.

Drawings illustrate a piston 110 is provided at the container body 100; however, any containers which can store contents, such as a tube container or a blow-forming container, are possible.

The pumping member 200 coupled to an upper portion of the container body 100 and discharging contents stored in the container body through a pumping operation includes a pump housing 210, a piston rod 220, a seal cap 230 and an elastic body 240.

The pumping housing 210 closes an opened upper portion of the container body 100 and is coupled thereto. The pumping housing 210 includes a cylinder 211 having a content inflow hole 212 formed at a lower end thereof such that contents stored in the container body 100 may flow in, wherein at an inner lower portion of the cylinder 211 is installed a check valve 213 which opens/closes the content inflow hole 212 according to an operation of a button member 300.

Furthermore, at an inner circumferential surface of the pump housing 210 is provided a protrusion 214 which limits the ascent of a seal cap 230 so as to prevent the seal cap 230 from being separated from the pump housing 210 in a process that the seal cap 230 ascends along while a button member 300 is ascending.

Furthermore, at an upper end of the pump housing 210 is provided a securing groove 215 such that a lower end of an elastic body 240 moving the button member 300 to an upward direction may be secured therein.

Meanwhile, at an outer side of the pump housing 210 is detachably coupled an over cap 400 encasing the button member 300, wherein the over cap 400 is coupled to the pump housing 210 at a normal state and thereby prevents malfunction of the button member 300, thus preventing foreign material from entering through a discharging hole 310.

The piston rod 220 is coupled to a coupling part 320 of the button member 300 and moves along according to the ascent/descent of the button member 300. A lower portion of the piston rod 220 is disposed at an inner side of the cylinder 211, making it possible to move contents having flowed in the cylinder 211 to an upper portion thereof. For this purpose, the piston rod 220 includes a content movement passage (S) where contents move at an inner side thereof, such that the contents that flowed into the cylinder 211 may move to a discharging hole 310 of the button member 300.

Furthermore, the piston rod 220 includes a contents movement hole 221 at a lower portion of the side thereof such that contents may move to the contents movement passage (S).

The seal cap 230 is disposed, encasing the piston rod 220, and changes inner pressure of the cylinder 211 as moving along an inner wall of the cylinder 211 when the button member 300 ascends/descends. At an inner side of the seal cap 230 is provided an opening/closing tip 231 which opens/closes the content movement hole 221, wherein the opening/closing tip 231 is configured to be closely contacted to an outer circumferential surface of the piston rod 220 at a lower portion of the content movement hole 221 and then separated in a narrow margin when the piston rod 220 descends according to pressurization of the button member 300, thereby forming a space where contents move and at the same time, and at the same time, opening the content movement hole 221.

The seal cap 230 is possible for flexible osculation when it is closely contacted to an outer circumferential surface of the piston rod 220, and it is preferable to be made of soft material so as to move easily along an inner wall of the cylinder 211.

Meanwhile, at an outer circumferential surface is provided a support protrusion 232 supported by a protrusion 214, wherein the support protrusion 232 meets a lower end of the protrusion 214 in a process that the seal cap 230 ascends and limits the ascent of the seal cap 230.

The elastic body 240 is disposed between the pump housing 210 and the button member 300 and provides an elastic force such that the button member 300 may move to an upward direction. A lower end of the elastic body 240 is secured to a securing groove formed at an upper end of the pump housing 210, and an upper end thereof is supported by a support groove formed at an inner side of the button member 300.

The button member 300, which is disposed at an upper portion of the pumping member 200 and delivers a pressure generated by a user's control to the pumping member 200 and then causes a pumping operation, includes a discharging hole 310 such that contents can be discharged according to the pumping operation of the pumping member 200.

A coupling part 320 to which the piston rod 220 is coupled extends in a downward direction at an inner side of the button member 300. The coupling part 320 pressurizes the seal cap 230 when the button member 300 descends and guides a downward movement of the seal cap 230, and further connects the content movement passage (S) and the discharging hole 310 such that contents can move to the discharging hole 310 through the content movement passage (S).

Meanwhile, at inner side of the button member 300 is provided a support groove 330 which supports an upper end of the elastic body 240.

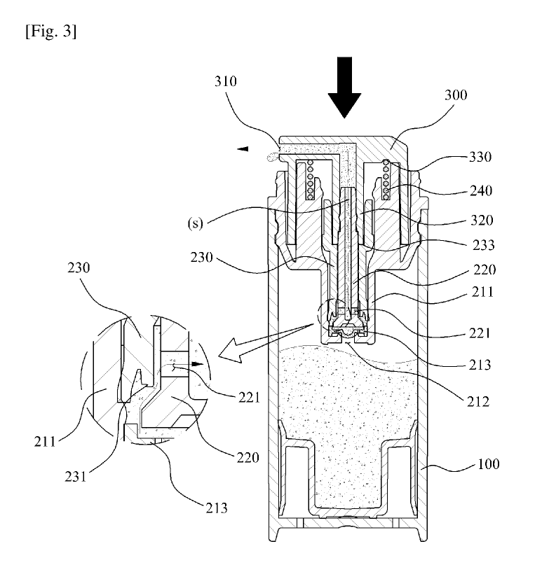

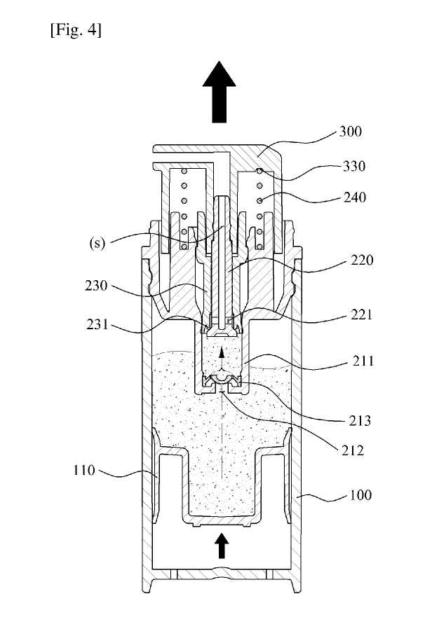

Hereinafter, an operational state of a dispenser container according to an exemplary embodiment will be described with reference to FIGS. 3 and 4. FIGS. 3 and 4 are views illustrating an operational state of a dispenser container according to an exemplary embodiment. Referring FIGS. 3 and 4, when the button member 300 is pressurized in a state of contents having flowed into a cylinder 211, a piston rod 220 coupled to the button member 300 descends along with the button member 300. At this moment, in a process that the button member 300 descends, a coupling part 320 pressurizes a pressurization face 233 of a seal cap 230 and thereby the seal cap 230 descends as well.

As described above, when the piston rod 220 and the seal cap 230 descend, an inner pressure of the cylinder 211 changes and thereby contents having flowed into the cylinder 211 move to a content movement passage (S) through a content movement hole 221 and are discharged to the outside through a discharging hole 310. At this time, the opening/closing tip 213 is separated with a narrow margin from an outer circumferential surface of the piston rod 220 when the piston rod 220 descends according to pressurization of the button member 300.

Next, when the button member 300 releases pressurizing, the button member 300 ascends by an elastic force of an elastic body 240. At this time, a piston coupled to the button member 300 ascends together, and a lower portion of the piston rod 220 meets an opening/closing tip 213 of the seal cap 230 while the piston rod 220 is ascending, and thereby moves the seal cap 230 up in an upward direction.

When the seal cap 230 ascends as in the above, a check valve 213 opens a content inflow hole 212 and thereby contents stored in the container body 100 flow into the cylinder 211.

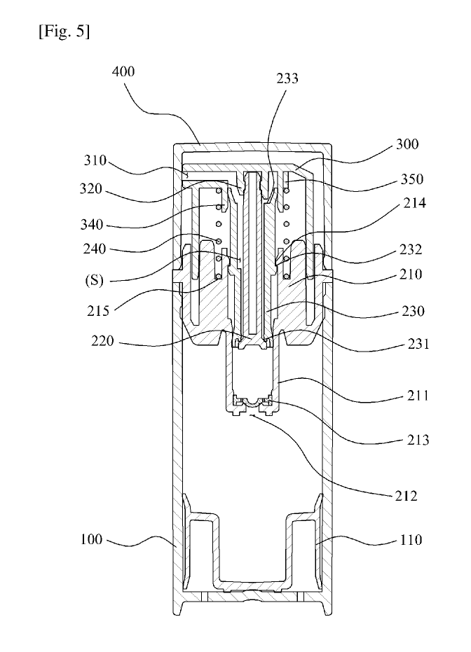

Hereafter, referring FIG. 5, a dispenser container according to another exemplary embodiment. FIG. 5 is a cross-sectional view illustrating a dispenser container according to another exemplary embodiment. Referring FIG. 5, a dispenser container according to an exemplary embodiment includes a container body 100, a pumping member 200, and a button member 300. Since the container body 100 has the same structure and function with an exemplary embodiment as described in the above, a pumping member 200 and a button member 300 are to be described hereafter.

The pumping member 200, coupled to the container body 100 and discharging contents stored in the container body 100 through a pumping operation, includes a pump housing 210, a piston rod 220 a seal cap 230 and an elastic body 240.

Since, the pump housing 210, as described in the above, is the same in its structure and function with that of an exemplary embodiment, detailed description will be omitted.

The piston rod 220 is coupled to a coupling part 320 of the button member 300 and moves along with the ascent of the button member 300. In a general pump structure, when contents are discharged, the contents pass through a content movement passage provided at an inner side of a piston rod through content movement hole provided at an inner side of a piston rod; however, according to another exemplary embodiment, it is characterized that contents are discharged through a space formed between a piston rod 220 and a seal cap 230, not that contents moves into an interior of the piston rod 220. For this purpose, the seal cap 230 is configured to encase the piston rod 220 and to form a space with an inner circumferential surface thereof separated in a predetermined distance from an outer circumferential surface of the piston rod 220.

Meanwhile, at a lower inner side of the seal cap 230 is provided an opening/closing tip 231 which opens/closes a lower end of the content movement passage (S), wherein, when in a normal state, the opening/closing tip 231 is closely contacted to a lower outer circumferential surface of the piston rod 220 and prevents contents from moving to the content movement passage (S) and, when the piston rod 220 descends according to a pressurization of the button member 300, the opening/closing tip 231 is separated in a narrow margin from an outer circumferential surface of the piston rod 220 and opens the content movement passage (S), thereby making contents move to a upper portion thereof.

The seal cap 230 is preferred to be made of soft material so as to have a flexible contact when the seal cap 230 is closely contacted to an outer circumferential surface of the piston rod 230 and to move easily along an inner wall of a cylinder 211.

Meanwhile, at an outer circumferential surface of the seal cap 230 is provided a support protrusion 232 which is supported by the protrusion 214, wherein the support protrusion 232 meets a lower end of the protrusion 214 while the seal cap 230 is ascending and limits the seal cap 230 ascending.

The elastic body 240 is disposed between the pump housing 210 and the button member 300 and provides an elastic force such that the button member 300 move in an upward direction. A lower end of the elastic body 240 is secured to a securing groove 215 formed at an upper end of the pump housing 210, and an upper end thereof is supported by a support body 350 provided at an inner side of the button member 300.

The button member 300, disposed at an upper portion of the pumping member and delivering a pressure generated by a user's manipulation, thereby causing a pumping operation, comprises a discharging hole 310 such that contents can be discharged by a pumping operation of the pumping member 200.

A coupling part 320, where the piston rod 220 is coupled, extends to a downward direction at an inner side of the button member 300, wherein the coupling part 320 is characterized to pressurize the seal cap 230 when the button member 300 descends and guide the seal cap 230 to move in a downward direction.

The coupling part 320 has a configuration that the length of a front face part disposed to a direction of the discharging hole 310 is short, and the length of a rear face is long. Since the front face part is short, it is possible to prevent interference when contents are discharged through an upper portion of the content movement passage (S). Meanwhile the rear face part, whose length is long, pressurizes a pressurization face 233 of the seal cap 230 and moves the seal cap 230 to a downward direction.

Meanwhile, at an inner side of the button member 300 forms a space where an upper portion of the seal cap 230 ascends/descends, and further comprises a connection tube 340 which connects the content movement passage (S) and the discharging hole 310. Therefore, it is preferable that an upper portion of the seal cap 230 is formed of a shape of a piston, ascending/descending in a close contact with an inner circumferential surface of the connection tube 340 so as to prevent the leakage of contents which move to the discharging hole 310 through the content movement passage (S).

Meanwhile, at an inner side of the button member 300 is provided a support body 350 which supports an upper end of the elastic body 240.

The configuration of the rest is the same as described in an exemplary embodiment; hence, detailed description is omitted.

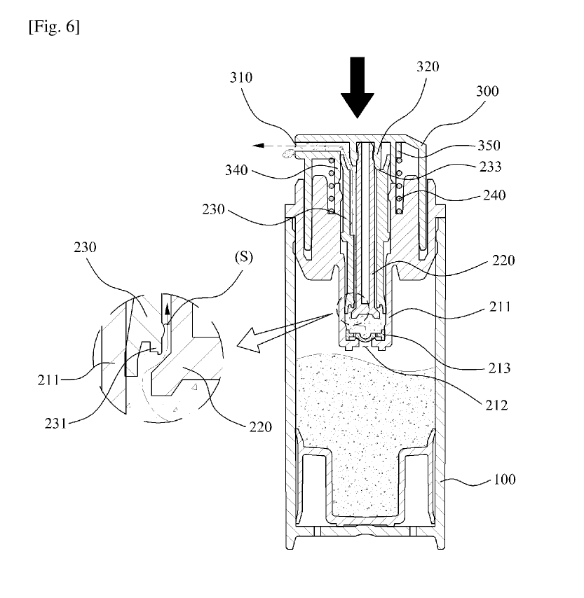

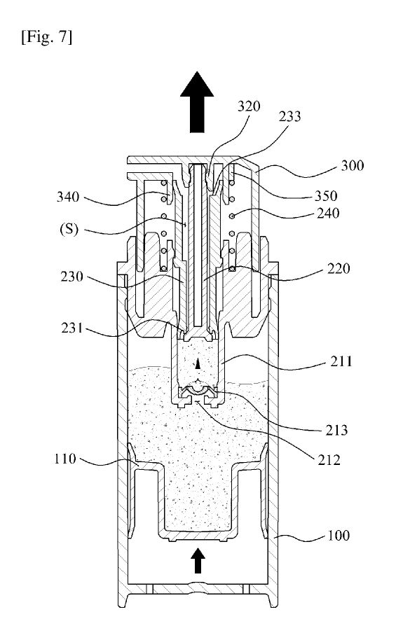

Hereinafter, an operational state of a dispenser container according to an exemplary embodiment will be described with reference to FIGS. 6 and 7. FIGS. 6 and 7 are views illustrating an operational state of a dispenser container according to an exemplary embodiment. Referring FIGS. 6 and 7, when the button member 300 is pressurized in a state of contents having flowed into a cylinder 211, a piston rod 220 coupled to the button member 300 descends along with the button member 300. At this moment, in a process that the button member 300 descends, a coupling part 320 pressurizes a pressurization face 233 of a seal cap 230 and thereby the seal cap 230 descends as well.

As described in the above, when a piston rod 220 and a seal cap 230 descend, an inner pressure of a cylinder 211 changes, and then contents having flowed into the cylinder 211 move to a content movement passage (S) and are discharged to the outside through a discharging hole 310. At this time, the opening/closing tip 231 is closely contacted to a lower outer circumferential surface of the piston rod 220 and prevents contents from moving to the content movement passage (S). After that, as the piston rod 220 first descends in a process that a coupling part 320 of the button member 300 is separated from a pressurization face 233 of the seal cap 230, the opening/closing tip 231 gets separated with a small margin from an outer circumferential surface of the piston rod 220 and opens the content movement passage (S), making the contents move to an upper portion thereof through the content movement passage (S).

Next, when pressurization of the button member 300 is released, the button member 300 ascends by an elastic force of an elastic body 240. At this time, a piston coupled to the button member 300 ascends together, and a lower portion of the piston rod 220 meets an opening/closing tip 213 of the seal cap 230 while the piston rod 220 is ascending, and thereby moves the seal cap 230 up in an upward direction.

When the seal cap 230 ascends as in the above, a check valve 213 opens a content inflow hole 212 and thereby contents stored in the container body 100 flow into the cylinder 211.

The presently described embodiments do not have a structure of a conventional complicated pumping member, but have a structure of a pumping member simply comprising a pump housing, a piston rod, a seal cap and an elastic body. Therefore, it is possible not only to reduce a manufacturing expense but shorten an overall manufacturing time through simplifying the assembly procedure.

As described above, optimal embodiments have been disclosed in the drawings and the specification. Although specific terms have been used herein, these are only intended to describe exemplary embodiments and are not intended to limit the meanings of the terms or to restrict the scope of the accompanying claims. Therefore, those skilled in the art will appreciate that various modifications and other equivalent embodiments are possible from the above embodiments. Accordingly, the scope of the accompanying claims should be defined by the technical spirit of the description.

1. A dispenser container, the dispenser container comprising:
a container body for storing contents;
a pumping member coupled to an upper portion of the container body and discharging the contents stored in the container body to the outside through pumping operation; and
a button member, disposed at an upper portion of the pumping member, delivering pressure according to user's manipulation of the pumping member and causing pumping operation, further forming a discharging hole where contents are discharged,
wherein the pumping member includes:
a pump housing coupled to an upper portion of the container body and forming a cylinder at a center portion thereof;
a piston rod, an upper portion of which is coupled to an inner side of the button member and a lower portion of which is disposed at an inner side of the cylinder and moves along with an ascent/descent of the button member, further consisting of a content movement passage at an inner side thereof such that contents can move, and a content movement hole at a lower portion thereof such that contents can move to the content movement passage;
a seal cap, made of soft material, encasing the piston rod and moving along an inner wall of the cylinder when the button member ascends/descends and thereby changing inner pressure of the cylinder, further consisting of an opening/closing tip so as to be separated with a small gap from an outer circumferential surface of the piston rod when the piston rod descends according to pressurization of the button member and thereby to open a content movement hole; and
an elastic body providing an elastic force such that the button member can move to an upward direction.

2. The dispenser container of claim 1,
wherein a coupling part with the piston rod coupled is formed at the button member,
wherein the coupling part pressurizes the seal cap when the button member descends and guides a downward direction of the seal cap, and connects the content movement passage and the discharging hole such that contents can move to the discharging hole through the content movement passage.

3. The dispenser container of claim 1, wherein at an upper end of the pump housing is formed a securing protrusion where a lower end of the elastic body secures, and at an inner side of the button member is formed a support groove supporting an upper end of the elastic body.

4. A dispenser container, the dispenser container comprising:
a container body for storing contents;
a pumping member coupled to an upper portion of the container body and discharging the contents stored in the container body to the outside through a pumping operation; and
a button member disposed at an upper portion of the pumping member, delivering a pressure according to user's manipulation to the pumping member and causing pumping operation, further consisting of a discharging hole where contents are discharged,
wherein the pumping member includes:
a pump housing coupled to an upper portion of the container body and forming a cylinder at a center portion thereof;
a piston rod, an upper portion of which is coupled to an inner side of the button member and a lower portion of which is disposed at an inner side of the cylinder and moves along with an ascent/descent of the button member;
a seal cap, made of soft material, which encases the piston rod and moves along an inner wall of the cylinder when the button member ascends/descends and thereby changes inner pressure of the cylinder, further comprising an opening/closing tip so as to be separated with a small gap from an outer circumferential surface of the piston rod when the piston rod descends according to pressurization of the button member; and
an elastic body providing an elastic force for moving the button member to an upward direction,
wherein a content movement passage is provided between the seal cap and the piston rod such that contents having moved into the cylinder can move to a discharging hole when the button member is pressurized.

5. The dispenser container of claim 4, wherein at an inner side of the button member is formed a space for an upper portion of the seal cap ascending/descending, and a connection tube connecting the content movement passage and the discharging hole is provided therein.

6. The dispenser container of claim 5, wherein the upper portion of the seal cap has a piston shape for ascending/descending in a state of being contacted to an inner circumferential surface of the connection tube so as to prevent leakage of the contents moving to the discharging hole through the content movement passage.

7. The dispenser container of claim 4, wherein at the button member is provided a coupling part with the piston rod coupled,
wherein the coupling part guides the seal cap to a downward direction by pressurizing the seal cap when the button member descends, and is configured not to be interfered when discharging contents by making a length of a front surface part of the coupling part disposed to a direction of the discharging hole.

8. The dispenser container of claim 7, wherein at an upper portion of the seal cap is formed a pressurization face pressurized by the coupling part.

9. The dispenser container of claim 5, wherein at an inner circumferential surface of the pump housing is provided a protrusion which limits the ascent of the seal cap, and at an outer circumferential surface of the seal cap is provided a support protrusion supported by the protrusion.
